(19) United States
(12) Patent Application Publication
(10) Pub. No.: US 2022/0075120 A1
(43) Pub. Date: Mar. 10, 2022

(54) OPTICAL FIBER AND MANUFACTURING METHOD THEREOF

(71) Applicant: Nippon Telegraph and Telephone Corporation, Tokyo (JP)

(72) Inventors: Katsuhiko Hirabayashi, Musashino-shi, Tokyo (JP); Satomi Katayose, Musashino-shi, Tokyo (JP); Yuji Fujiwara, Musashino-shi, Tokyo (JP); Ryoichi Kasahara, Musashino-shi, Tokyo (JP)

(21) Appl. No.: 17/418,572

(22) PCT Filed: Oct. 17, 2019
(86) PCT No.: PCT/JP2019/040819

§ 371 Date: Jun. 25, 2021

(30) Foreign Application Priority Data
Jan. 8, 2019 (JP) 2019-001373

(51) Int. Cl. G02B 6/26

(52) U.S. Cl. CPC G02B 6/262

(57) ABSTRACT

To provide an optical connector that can prevent degradation of end faces of cores using a simple structure. The optical connector is adapted to connect single-mode optical fibers for visible light with a wavelength of less than or equal to 650 nm to ultraviolet light, specifically, connect the optical fibers by allowing ferrules having fixed thereto the respective optical fibers to be inserted into a sleeve and allowing the ferrules to butt against each other, in which a film of nitride, oxide, or fluoride is formed on an end face of each of the optical fibers and the ferrules.

### TECHNICAL FIELD

The present invention relates to an optical connector for connecting single-mode optical fibers for visible light to ultraviolet light, and a method for producing the same.

### BACKGROUND ART

SC, FC, or LC optical connectors, for example, are used to connect single-mode optical fibers with a mode field diameter (MFD) of about 9 μm for communication wavelength bands of 1.3 μm and 1.55 μm. The FC and LC connectors have also come to be used for the visible to ultraviolet regions. However, MFD of single-mode optical fibers for visible light to ultraviolet light is as small as 2 to 4 μm because the wavelength of the light is short, and even though the power of the single-mode optical fibers for visible light to ultraviolet light is the same as that of the single-mode optical fibers for the communication wavelength bands, the power density is higher by an order of magnitude. Further, since the energy of visible light to ultraviolet light is higher than the energy of light in the communication wavelength bands, end faces of the fibers would degrade more severely (for example, see Patent Literature 1).

When optical fibers through which light in the visible to ultraviolet regions propagates are connected by an FC connector or are inserted into or pulled out of the FC connector, end faces of the optical fibers would degrade and the core portions would break, resulting in significantly increased transmission loss. For example, FIG. 1 illustrates an end face of an optical fiber after being inserted into and pulled out of an optical connector through which light has been passed. Specifically, FIG. 1 illustrates a case where light with a wavelength of 405 nm has been passed for several hundred hours; FIG. 1(a) illustrates an example in which light with a power of 20 mW has been passed, and FIG. 1(b) illustrates an example in which light with a power of 60 mW has been passed. It is found that the core portion around the center has degraded. After light is passed through an optical fiber even for several hours, transmission loss may become as large as several ten dB or more if the optical fiber is inserted into and pulled out of an optical connector.

This is related to a phenomenon that when blue light with a wavelength of less than or equal to 500 nm is input to an optical fiber, an end face of a core of the optical fiber would swell. While an optical connector is connected to optical fibers, the end faces of cores of the optical fibers are physically in contact with each other. Thus, the swelling of the cores can be suppressed. When the optical connector is detached from the optical fibers, the stress is released, causing the end faces of the cores to swell. Thus, if the optical fibers are repeatedly pulled out of and inserted into the optical connector, the core portions would degrade (for example, see Non-Patent Literature 1). In particular, the degradation would be significant when blue light with a wavelength of less than or equal to 450 nm is input.

Typically, an end face of each ferrule of an optical connector and an end face of each optical fiber including a core portion are polished so as to be flush with each other. Further, the end faces of the ferrules are polished into slightly convex planes (referred to as PC polish) so as to allow cores of opposed optical fibers to become physically in contact with each other.

FIG. 2 illustrates the structure of a conventional optical connector for connecting single-mode optical fibers for visible light to ultraviolet light. Optical fibers 22a and 22b including single-mode cores 21a and 21b are inserted into ferrules 23a and 23b, respectively, and coreless fibers (end caps) 24a and 24b are fusion-spliced to end faces of the optical fibers 22a and 22b, respectively. A sleeve 25 incorporates lenses 27a and 27b. A light beam 26a emitted from the end cap 24a is converted into a collimated light beam 28 by the lens 27a, and a light beam 26b focused by the lens 27b is allowed to become incident on the end cap 24b.

Conventionally, for connecting single-mode optical fibers for visible light to ultraviolet light, coreless fibers each having a length of about 300 μm are fused as end caps to the end faces of the optical fibers, and the optical fibers are optically coupled via lenses. Accordingly, the optical power density at the connection end faces is lowered and physical contact between the end faces of the cores is avoided so that degradation of the end faces of the cores is prevented. Such a configuration is, however, problematic in requiring high accuracy for aligning the optical axes of the lenses with the optical axes of the optical fibers and also requiring a complex structure and thus high cost.

### CITATION LIST

### Patent Literature

Patent Literature 1: Japanese Patent Laid-Open No. 2017-054110

### Non-Patent Literature

Non-Patent Literature 1: C. P. Gonschior, K.-F. Klein, M. Menzel, T. Sun, K. T. V. Grattan, “Investigation of single-mode fiber degradation by 405-nm continuous-wave laser light”, Optical Engineering 53(12), 122512 (December 2014).

### SUMMARY OF THE INVENTION

It is an object of the present invention to provide an optical connector that can prevent degradation of end faces of cores using a simple structure, and a method for producing the same.

To achieve such an object, a first aspect of the present invention is an optical connector for connecting single-mode optical fibers for visible light with a wavelength of less than or equal to 650 nm to ultraviolet light, the optical connector being adapted to connect the optical fibers by allowing ferrules having fixed thereto the respective optical fibers to be inserted into a sleeve and allowing the ferrules to butt against each other, the optical connector including a film of nitride, oxide, or fluoride formed on an end face of each of the optical fibers and the ferrules.

According to a second aspect, in the first aspect, the end face of at least one of the optical fibers is located at a position deeper than the end face of a corresponding one of the ferrules, and a gap is formed between the end faces of the optical fibers when the ferrules are inserted into the sleeve.

A third aspect is an optical connector for connecting single-mode optical fibers for visible light with a wavelength of less than or equal to 650 nm to ultraviolet light, the optical connector being adapted to connect the optical fibers by allowing ferrules having fixed thereto the respective optical fibers to be inserted into a sleeve and allowing the ferrules to butt against each other, in which an end face of each of the optical fibers is flush with an end face of a corresponding one of the ferrules, a spacer is inserted between the end faces of the ferrules, and a gap is formed between the end faces of the optical fibers.

### Effects of the Invention

According to the present invention, protective films are formed on end faces of optical fibers so that contact between the end faces of the optical fibers is avoided. Thus, degradation of end faces of cores can be prevented.

### BRIEF DESCRIPTION OF DRAWINGS

FIG. 1 is a photograph of an end face of an optical fiber after being inserted into and pulled out of an optical connector through which light with a wavelength of 405 nm has been passed in which FIG. 1(a) illustrates an example in which light with a power of 20 mW has been passed and FIG. 1(b) illustrates an example in which light with a power of 60 mW has been passed.

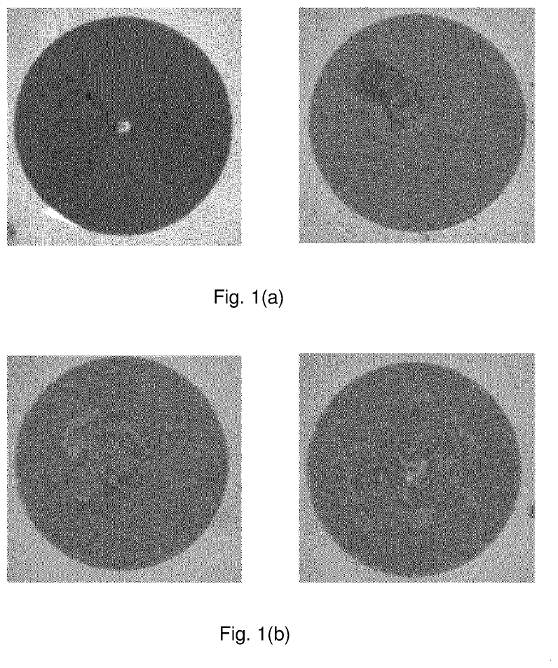

FIG. 2 is a view illustrating the structure of a conventional optical connector for connecting single-mode optical fibers for visible light to ultraviolet light.

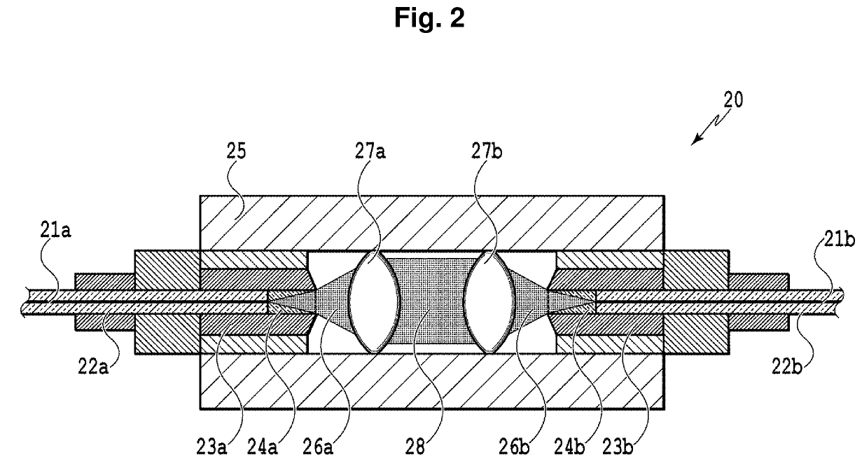

FIG. 3 is a view illustrating the structure of an optical connector for connecting single-mode optical fibers for visible light to ultraviolet light according to a first embodiment of the present invention.

FIG. 4 is a view illustrating the structure of an optical connector for connecting single-mode optical fibers for visible light to ultraviolet light according to Example 2 of a second embodiment.

FIG. 5 is a view illustrating a method of forming a protective film for the optical connector according to Example 2.

FIG. 6 is a view illustrating the structure of an optical connector for connecting single-mode optical fibers for visible light to ultraviolet light according to Example 3 of the second embodiment.

FIG. 7 is a view illustrating a configuration in which an anti-reflective coating is formed in the optical connector according to Example 3.

FIG. 8 is a view illustrating a configuration in which silicone is added to the optical connector according to Example 3.

FIG. 9 is a view illustrating a configuration in which angled polishing is applied to the optical connector according to Example 3.

FIG. 10 is a view illustrating the structure of an optical connector for connecting single-mode optical fibers for visible light to ultraviolet light according to Example 4 of the second embodiment.

FIG. 11 is a view illustrating the structure of an optical connector for connecting single-mode optical fibers for visible light to ultraviolet light according to Example 5 of the second embodiment.

FIG. 12 is a view illustrating the structure of an optical connector for connecting single-mode optical fibers for visible light to ultraviolet light according to Example 6 of the second embodiment.

FIG. 13 is a view illustrating a first exemplary method by which an end face of an optical fiber is made more dented than an end face of a ferrule.

FIG. 14 is a view illustrating a second exemplary method by which an end face of an optical fiber is made more dented than an end face of a ferrule.

FIG. 15 is a view illustrating a third exemplary method by which an end face of an optical fiber is made more dented than an end face of a ferrule.

FIG. 16 is a graph illustrating the results of insertion and pull-out tests performed using the optical connector of the present embodiment.

FIG. 17 is a view illustrating the structure of an optical connector for connecting single-mode optical fibers for visible light to ultraviolet light according to Example 5 of a third embodiment.

### DESCRIPTION OF EMBODIMENTS

Hereinafter, embodiments of the present invention will be described in detail with reference to the drawings. When visible light is passed through an optical fiber, a swelling phenomenon of a core would occur. To prevent such a phenomenon, a protective film is formed. Further, when optical fibers are inserted into or pulled out of an optical connector, opposed cores of the optical fibers come into physical contact with each other or become away from each other, which promotes degradation of the end faces of the cores. Thus, a structure is provided herein in which opposed optical fibers do not come into physical contact with each other. For example, each optical fiber is fixed such that an end face of its core is located at a depth of about 1 to 10 μm from an end face of a corresponding ferrule, and when an optical connector is connected to the two optical fibers, an air gap of 2 to 20 μm is formed between the end faces of the cores. Desirably, a gap of 2 to 5 μm is provided. Accordingly, contact between the end faces of the cores is avoided, and degradation of the end faces can thus be prevented. Alternatively, inserting a spacer between the opposed ferrules can avoid physical contact between the end faces of the cores.

### First Embodiment

A structure will be described in which an end face of a core is located at a position deeper than an end face of a ferrule.

### Example 1

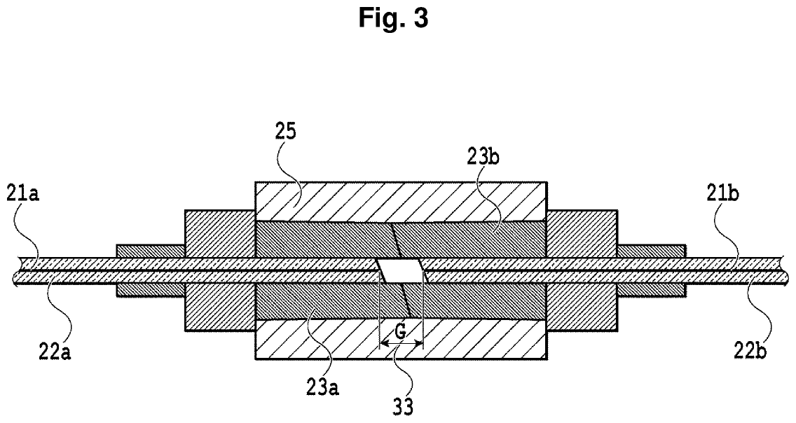

FIG. 3 illustrates the structure of an optical connector for connecting single-mode optical fibers for visible light to ultraviolet light according to a first embodiment of the present invention. Optical fibers 22a and 22b including single-mode cores 21a and 21b are fixed to ferrules 23a and 23b, respectively, and the ferrules 23a and 23b are inserted into a sleeve 25 and are butted against each other. The optical fibers 22a and 22b are pure silica core fibers for visible light with a wavelength of less than or equal to 650 nm to ultraviolet light.

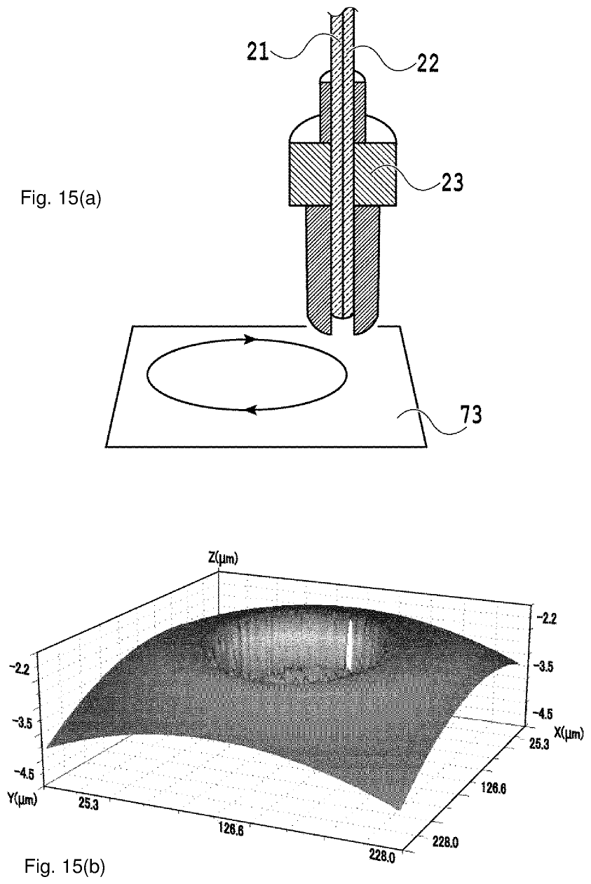

End faces of the optical fibers 22a and 22b and the ferrules 23a and 23b are polished (i.e., subjected to angled PC (APC) polishing) at an angle of 8 degrees with respect to the optical axis. The end faces of the optical fibers 22a and 22b are allowed to be more dented than the end faces of the ferrules 23a and 23b, respectively, using a method described later with reference to FIG. 15. Specifically, after each ferrule with a corresponding optical fiber fixed thereto is subjected to angled PC polishing, the end faces are polished with a cerium oxide polishing solution so that the end face of the optical fiber is allowed to be more dented than the end face of the ferrule by about 2 μm. When the ferrules 23a and 23b are inserted into the sleeve 25, a gap G33 of about 5 μm is formed between the end faces. Since the end faces are angled at 8 degrees with respect to the optical axis, reflection is suppressed.

### Second Embodiment

According to the first embodiment, contact between the end faces is avoided, and thus, degradation of the end faces can be suppressed. However, when light with a wavelength of less than or equal to 500 nm is passed through the optical fibers, the end faces of the cores would swell, which results in increased transmission loss. To suppress such swelling, a protective film, such as a nitride film, an oxide film, or a fluoride film, is formed to a thickness of 0.5 to 3 μm on the end face of each core. The thickness is desirably 2 μm. To reduce reflection loss due to the protective film, an anti-reflective (AR) coating is further attached to the protective film. In addition, to reduce reflection loss, the end face of each core is inclined at an angle of not 90 degrees but 90 degrees±1 to 10 degrees with respect to the optical axis. The angle is desirably 8 degrees.

### Example 2

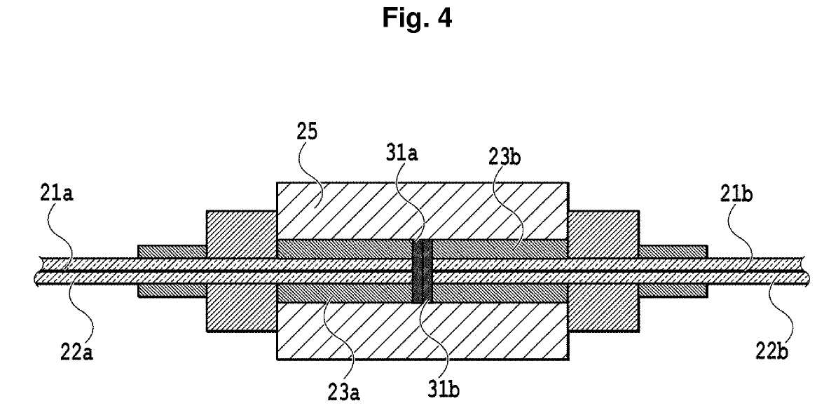

FIG. 4 illustrates the structure of an optical connector for connecting single-mode optical fibers for visible light to ultraviolet light according to Example 2 of a second embodiment. The optical fibers 22a and 22b including the single-mode cores 21a and 21b are fixed to the ferrules 23a and 23b, respectively, and the ferrules 23a and 23b are inserted into the sleeve 25 and are butted against each other. The optical fibers 22a and 22b are pure silica core fibers for visible light with a wavelength of less than or equal to 650 nm to ultraviolet light. Si₃N₄ films 31a and 31b each having a thickness of 1.8 μm are formed as protective films on the end faces of the optical fibers 22a and 22b and the ferrules 23a and 23b, respectively, by sputtering.

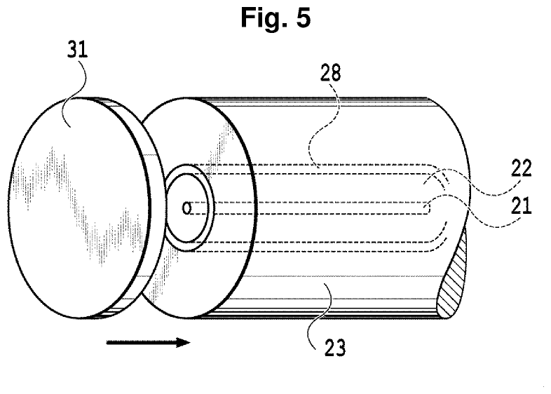

FIG. 5 illustrates a method of forming a protective film for the optical connector according to Example 2. The optical fiber 22 is inserted into the ferrule 23, and the optical fiber 22 is securely bonded to the ferrule 23 using an adhesive 28. The end faces of the optical fiber 22 and the ferrule 23 are subjected to vertical polishing or angled polishing, and then, a protective film 31 is formed thereon by vapor deposition or sputtering. For the polishing, PC polishing, SPC polishing, or APC polishing can be applied.

### Example 3

In the structure illustrated in FIG. 4, the Si₃N₄ films 31 are physically in contact with each other, and thus, when the optical fibers are inserted into or pulled of the optical connector, a mechanical force is applied. This causes degradation of the Si₃N₄ films 31. Thus, a gap G33 is introduced as in the first embodiment.

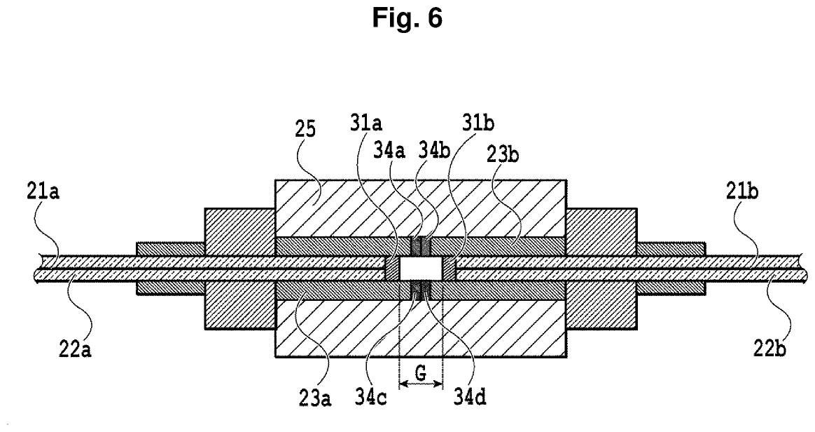

FIG. 6 illustrates the structure of an optical connector for connecting single-mode optical fibers for visible light to ultraviolet light according to Example 3. As in the first embodiment, the end faces of the optical fibers 22a and 22b are allowed to be more dented than the end faces of ferrules 23a and 23b, respectively, using the method described later with reference to FIG. 15. In Example 3, when the ferrules 23a and 23b are inserted into the sleeve 25, a gap G33 of about 4 μm is formed between the end faces.

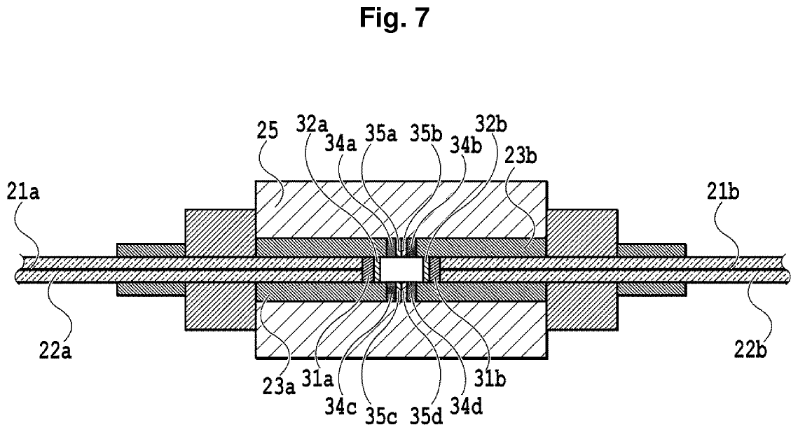

FIG. 7 illustrates a configuration in which an anti-reflective coating is attached to the optical connector according to Example 3. In addition, to increase transmissivity, further lower reflectivity, and protect each end face, it would be effective to form an anti-reflective coating as well as a protective film as illustrated in FIG. 7.

Si₃N₄ films 31a, 31b, and 34a to 34d each having a thickness of 1.8 μm are formed on the end faces of the optical fibers 22a and 22b and the ferrules 23a and 23b by sputtering. Further, SiO₂ films 32a, 32b, and 35a to 35d each having a thickness of 70 nm are formed as anti-reflective coatings on the end faces of the Si₃N₄ films 31a, 31b, and 34a to 34d, respectively, by sputtering. When the ferrules 23a and 23b are inserted into the sleeve 25 and their opposed end faces are butted against each other, a gap G33 of about 5 μm is formed between the end faces. Herein, for classification purposes, the protective films 31 and the anti-reflective coatings 32 are formed on the end faces of the fibers, and the protective films 34 and the anti-reflective coatings 35 are formed on the end faces of the ferrules. Though such films and coatings are identical, the protective films 31 and the anti-reflective coatings 32 are attached.

When a Si₃N₄ film with a thickness of 2 μm is formed on the end face of each optical fiber, transmissivity will vary depending on the wavelength due to multiple reflection interference at the interface between the film and the optical fiber and the interface between the film and the gap. Specifically, the wavelength dependence is 95% to 80%. Further, when a pair of fiber blocks are arranged facing each other and are connected, a cavity is formed, and vibration thereof becomes great up to 50% to 98%. To prevent this, it would be effective to form SiO₂ films 32a and 32b to a thickness of about 70 nm as anti-reflective coatings on the Si₃N₄ films 31a and 31b, respectively. Then, the transmissivity becomes 95% to 100% at one end, and the transmissivity becomes greater than or equal to 95% even when a pair of fiber blocks are arranged facing each other.

It is also possible to use alumina (Al₂O₃) films instead of the Si₃N₄ films, and if an anti-reflective coating of SiO₂ (114 nm)/SiN (21.5 nm)/SiO₂ (86.5 nm) is formed on each alumina film with a thickness of 1.8 μm, a transmissivity of greater than or equal to 95% is obtained at a wavelength of around 405 nm.

With the Si₃N₄ films 31a and 31b, degradation of the end faces of the fibers is avoided and air is blocked. Thus, the swelling phenomenon of the end faces of the cores can be suppressed.

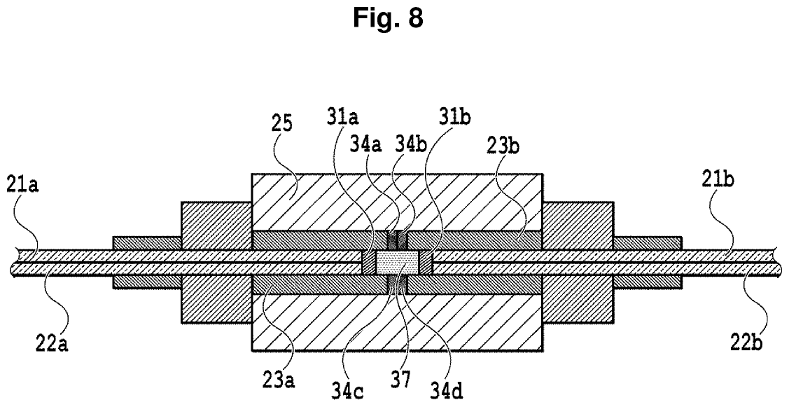

FIG. 8 illustrates a configuration in which silicone is added to the optical connector according to Example 3. Instead of attaching anti-reflective coatings, it is also possible to fill the gap G33 with silicone oil or silicone gel 37 as matching oil or matching gel.

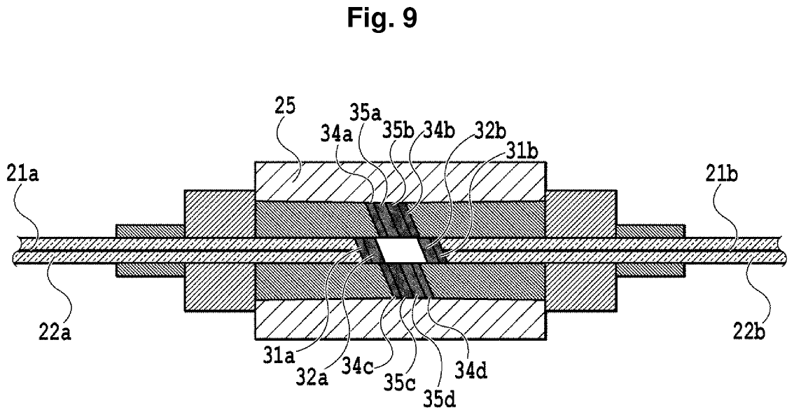

FIG. 9 illustrates a configuration in which angled polishing is applied to the optical connector according to Example 3. In addition, polishing each of the end faces of the optical fibers 22a and 22b and the ferrules 23a and 23b at an angle of 8 degrees with respect to the optical axis can also suppress reflection.

### Example 4

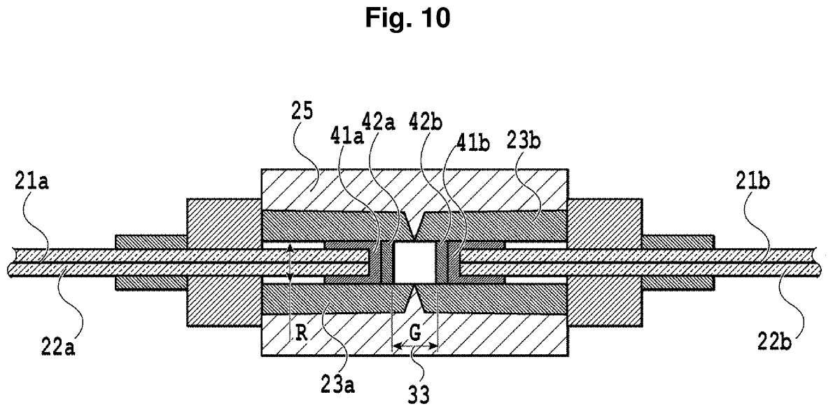

FIG. 10 illustrates the structure of an optical connector for connecting single-mode optical fibers for visible light to ultraviolet light according to Example 4. Only the differences from the optical connector of Example 2 will be described. The end faces of the optical fibers 22a and 22b have been cut with a fiber cutter, and are at right angles to the optical axis. Si₃N₄ films 41a and 41b each having a thickness of 1.8 μm are formed on the end faces of the cores 21a and 21b, respectively, and are also formed to a thickness of about 2 μm in regions of about 1.5 μm around the side faces of the respective optical fibers. Thus, the hole diameters of the ferrules 23a and 23b are 129 μm, which are greater than the typical hole diameter of 125 μm. Further, SiO₂ films 42a and 42b each having a thickness of 70 nm are attached as anti-reflective coatings to the end faces of the Si₃N₄ films 31a and 31b, respectively.

### Example 5

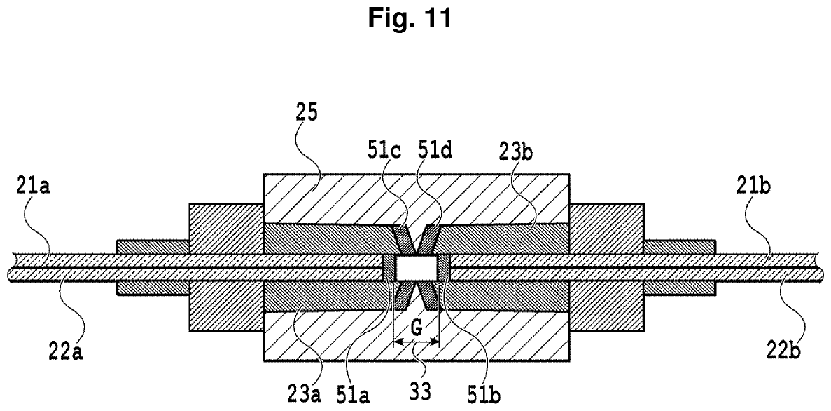

FIG. 11 illustrates the structure of an optical connector for connecting single-mode optical fibers for visible light to ultraviolet light according to Example 5. Only the differences from the optical connector of Example 2 will be described. Although Example 4 has illustrated a structure in which Si₃N₄ films 51a and 51b are formed first and then the fibers are inserted into the respective ferrules, Example 5 illustrates a structure in which the fibers are inserted into the respective ferrules first, and then the Si₃N₄ films 51a and 51b are formed. Although Example 5 illustrates an example in which anti-reflective coatings are not attached, such coatings may also be attached.

### Example 6

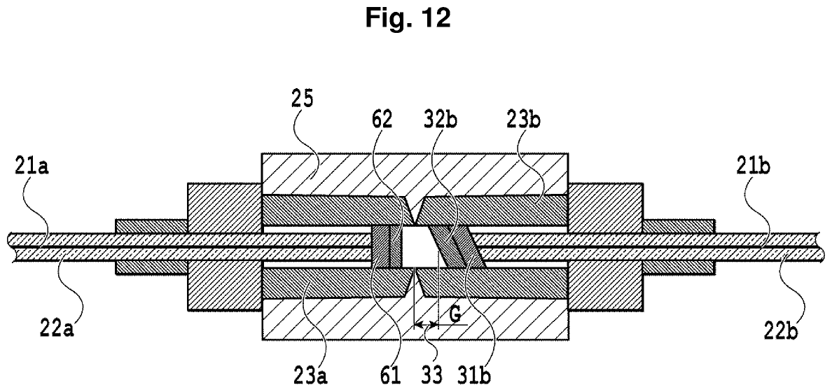

FIG. 12 illustrates the structure of an optical connector for connecting single-mode optical fibers for visible light to ultraviolet light according to Example 6. In the optical fiber 22a on the left side of FIG. 12, the end face of the core 21a is at right angles to the optical axis, and has formed thereon a Si₃N₄ film 61 with a thickness of 1.8 μm and a SiO₂ film 62 as an anti-reflective coating. The optical fiber 22b on the right side of FIG. 12 has the same structure as that of Example 1. In this manner, optical fibers with even different structures can be connected with the ferrules 23a and 23b butted against each other.

(Production Method)

Next, a method of fixing an end face of a core of an optical fiber within each ferrule will be described. First, an optical fiber is inserted into a ferrule and an end face of the optical fiber is arranged flush with an end face of the ferrule. Then, the optical fiber is pulled to the front by about 3 μm using a micromotion table. Such an operation should be performed with a microscope and is complex. Thus, the following method can be applied.

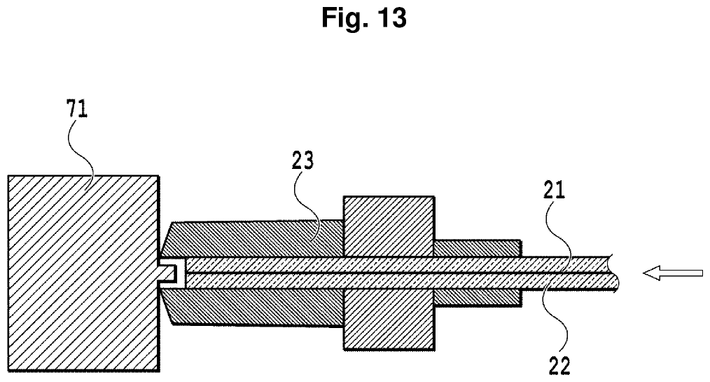

FIG. 13 illustrates a first exemplary method by which an end face of an optical fiber is made more dented than an end face of a ferrule. A jig 71 with a columnar protrusion with a diameter of about 120 μm, which is slightly smaller than the diameter of the optical fiber, and with a height of about 2 μm is prepared. The optical fiber 22 is inserted into the ferrule 23 and the end face of the optical fiber is arranged flush with the end face of the ferrule. Then, the end face of the optical fiber 22 is arranged to touch the protrusion of the jig 71 and is then pushed until the tip end of the ferrule 23 bumps into the jig 71, so that the optical fiber 22 is fixed to the ferrule 23. In this manner, the end face of the optical fiber can always be fixed at a position deeper than the end face of the ferrule by a given length.

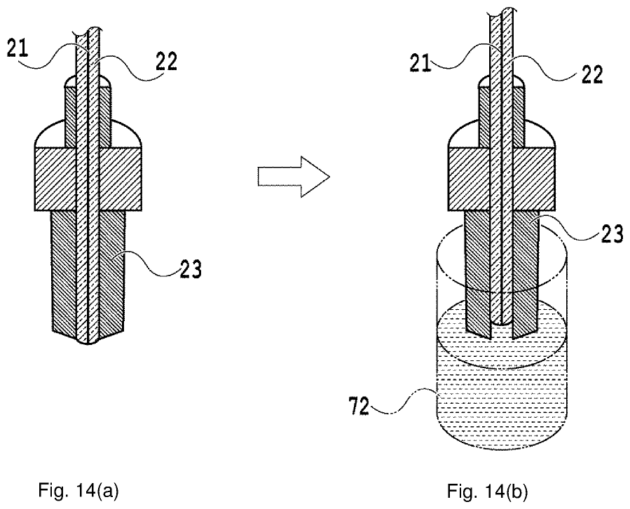

FIG. 14 illustrates a second exemplary method by which an end face of an optical fiber is made more dented than an end face of a ferrule. As illustrated in FIG. 14(a), the optical fiber 22 is inserted into the ferrule 23, and typical PC polishing or APC polishing is applied thereto. In this state, the optical fiber 22 protrudes beyond the tip end of the ferrule 23. Next, as illustrated in FIG. 14(b), the tip end of the ferrule 23 is immersed in hydrofluoric acid 72, so that only the tip end of the optical fiber is etched. The duration of immersion in the hydrofluoric acid 72 is adjusted so as to process the end face of the optical fiber to be located at a position deeper than the end face of the ferrule by about 2 μm.

FIG. 15 illustrates a third exemplary method by which an end face of an optical fiber is made more dented than an end face of a ferrule. As in the second example, the optical fiber 22 and the ferrule 23 subjected to PC polishing or APC polishing are prepared. When these are polished with cerium oxide abrasive paper 73, the end face of the optical fiber is ground, but the end face of the ferrule is not ground. Thus, only the tip end of the optical fiber is dented (FIG. 15(a)). Adding a cerium oxide polishing agent can further promote such an effect. Alternatively, cerium oxide powder is put on a raised film for polishing and then, polishing is performed with pure water. In this manner, the end face of the optical fiber is machined so as to be located at a position deeper than the end face of the ferrule by about 2 μm. FIG. 15(b) illustrates the results of observation of the shape of the tip end of the ferrule.

(Test Results)

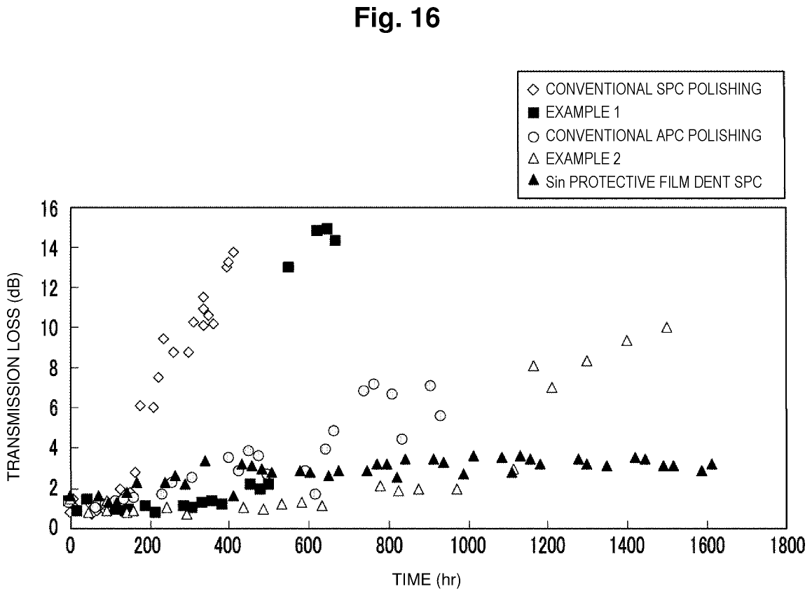

FIG. 16 illustrates the results of insertion and pull-out tests performed using the optical connector of the present embodiment. FIG. 16 illustrates the results of measuring transmission loss by passing light with a wavelength of 405 nm and a power of 50 mW and inserting and pulling out optical fibers into/from the optical connector in a thermostatic bath at 55° C. Performing an acceleration test with the environment temperature increased to 55° C. allows degradation to progress two to three times faster than at room temperature.

Regarding an FC optical connector subjected to only conventional SPC polishing (⋄ marks in the graph), transmission loss suddenly increases in 150 to 300 hours from the start of passing of light, and regarding an FC optical connector subjected to APC polishing (∘ marks in the graph), transmission loss increases after about 600 hours have elapsed. When the end face of the optical fiber is arranged at a position deeper than the end face of the ferrule and a gap is provided (solid marks in the graph) as in Example 1 of the first embodiment, transmission loss increases after 500 hours have elapsed.

In contrast, when a Si₃N₄ film is formed as a protective film (Δ marks in the graph) as in Example 2 of the second embodiment, transmission loss increases after about 1200 hours have elapsed. Further, when a Si₃N₄ film is formed as a protective film and a gap is further provided as in Example 2, transmission loss does not increase until about 2000 hours have elapsed.

As described above, forming a Si₃N₄ film on an end face of each optical fiber can suppress degradation of transmission loss, and further, providing a gap can suppress an increase in the transmission loss. Instead of the Si₃N₄ film, an alumina (Al₂O₃) film may be used. Forming an anti-reflective coating of SiO₂ (114 nm)/SiN (21.5 nm)/SiO₂ (86.5 nm) on an alumina film with a thickness of 1.8 μm can obtain a transmissivity of greater than or equal to 95% at a wavelength of around 405 nm.

Although a Si₃N₄ film and an Al₂O₃ film have been described as examples above, similar effects can also be obtained by using, for example, oxide of Si, Mg, Al, Hf, Nb, Zr, Sc, Ta, Ga, Zn, Y, B, or Ti (in particular, SiO₂, Nb₂O₅, TiO₂, or ZrO₂), nitride thereof (in particular, AlN, AlGaN, or BN), or fluoride thereof (in particular, MgF₂, CaF₂, BaF₂, or LiF).

The film thickness needs to be greater than or equal to 0.5 μm. However, when the film thickness is greater than or equal to μm, cracks may be generated in the film, which in turn may increase the transmission loss. Thus, the optimal film thickness is 0.5 to 3 μm. Herein, magnetron sputtering was used to form the film, but other formation methods (such as vapor deposition or CVD) may also be used. A film formed by ECR sputtering is the most effective for increasing the film quality.

### Third Embodiment

A structure in which a spacer is inserted between end faces of cores will be described.

### Example 7

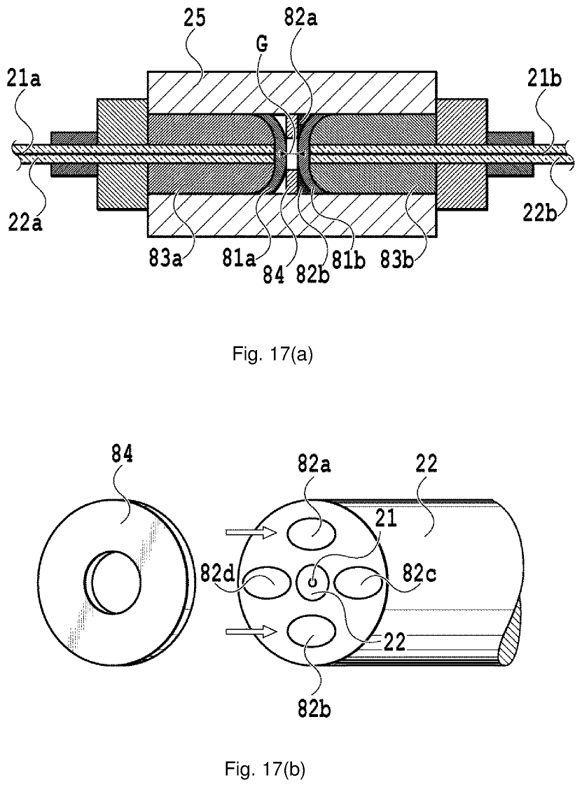

FIG. 17 illustrates the structure of an optical connector for connecting single-mode optical fibers for visible light to ultraviolet light according to Example 7. The optical fibers 22a and 22b including the single-mode cores 21a and 21b are fixed to the ferrules 83a and 83b, respectively, and the ferrules 83a and 83b are inserted into the sleeve 25 and are butted against each other. The optical fibers 22a and 22b are pure silica core fibers for visible light (405 nm).

The end faces of the optical fibers 22a and 22b are flush with the end faces of the ferrules 83a and 83b, respectively, and Si₃N₄ films 81a and 81b each having a thickness of 1.8 μm are formed on the end faces by sputtering. To provide a gap between the end faces of the cores, a spacer 84 of metal foil with a thickness of 10 μm is placed. The spacer 84 is a disk with a hole in the center to pass light as illustrated in FIG. 17(b), and is fixed to the end face of one of the ferrules 83b using optical adhesives 82a to 82d each having a thickness of about 1 μm.

In this manner, inserting the pair of ferrules 83a and 83b into the sleeve 25 can generate a gap G, which corresponds to the amount of the spacer 84, between the end faces of the cores, thus avoiding contact between the optical fibers. Therefore, even when the optical fibers were inserted into and pulled out of the optical connector while visible light was passed therethrough as in Example 1, no variation in the transmission loss was observed.

1. An optical connector for connecting single-mode optical fibers for visible light with a wavelength of less than or equal to 650 nm to ultraviolet light, the optical connector being adapted to connect the optical fibers by allowing ferrules having fixed thereto the respective optical fibers to be inserted into a sleeve and allowing the ferrules to butt against each other, the optical connector comprising:
a film of nitride, oxide, or fluoride formed on an end face of each of the optical fibers and the ferrules.

2. The optical connector according to claim 1, wherein the end face of at least one of the optical fibers is located at a position deeper than the end face of a corresponding one of the ferrules, and a gap is formed between the end faces of the optical fibers when the ferrules are inserted into the sleeve.

3. The optical connector according to claim 2, further comprising an anti-reflective coating formed on the film.

4. The optical connector according to claim 2, wherein the gap is filled with silicone oil or silicone gel.

5. The optical connector according to claim 1, wherein the end face of at least one of the optical fibers is inclined with respect to an optical axis.

6. The optical connector according to claim 1, wherein the film is formed on a side face of each of the optical fibers in the ferrules.

7. An optical connector for connecting single-mode optical fibers for visible light with a wavelength of less than or equal to 650 nm to ultraviolet light, the optical connector being adapted to connect the optical fibers by allowing ferrules having fixed thereto the respective optical fibers to be inserted into a sleeve and allowing the ferrules to butt against each other, wherein
an end face of each of the optical fibers is flush with an end face of a corresponding one of the ferrules,
a spacer is inserted between the end faces of the ferrules, and
a gap is formed between the end faces of the optical fibers.

8. A method for producing an optical connector for connecting single-mode optical fibers for visible light with a wavelength of less than or equal to 650 nm to ultraviolet light, the method comprising:
inserting the optical fibers into ferrules, respectively, and arranging end faces of the optical fibers to be flush with end faces of the respective ferrules;
pushing the end face of each of the optical fibers against a columnar protrusion of a jig, the protrusion having a diameter smaller than a diameter of each of the optical fibers, thereby allowing each of the ferrules to butt against the jig; and
fixing the optical fibers to the respective ferrules.

9. (canceled)

10. (canceled)

11. The optical connector according to claim 3, wherein the gap is filled with silicone oil or silicone gel.

12. The optical connector according to claim 2, wherein the end face of at least one of the optical fibers is inclined with respect to an optical axis.

13. The optical connector according to claim 3, wherein the end face of at least one of the optical fibers is inclined with respect to an optical axis.

14. The optical connector according to claim 4, wherein the end face of at least one of the optical fibers is inclined with respect to an optical axis.

15. The optical connector according to claim 2, wherein the film is formed on a side face of each of the optical fibers in the ferrules.

16. The optical connector according to claim 3, wherein the film is formed on a side face of each of the optical fibers in the ferrules.

17. The optical connector according to claim 4, wherein the film is formed on a side face of each of the optical fibers in the ferrules.

18. The optical connector according to claim 5, wherein the film is formed on a side face of each of the optical fibers in the ferrules.
